(19) United States
(12) Patent Application Publication
(10) Pub. No.: US 2006/0218306 A1
(43) Pub. Date: Sep. 28, 2006

(54) APPARATUS AND METHOD OF LOADING PROGRAM CODE THROUGH INTERFACE

(76) Inventor: Hui-Huang Chang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/277,045

(22) Filed: Mar. 21, 2006

(30) Foreign Application Priority Data
Mar. 23, 2005 (TW) 094108953

(51) Int. Cl. G06F 3/00

(52) U.S. Cl. 710/5

(57) ABSTRACT

An apparatus capable of utilizing interfaces to load program codes. The apparatus includes a storage unit, a first logic unit, and a second unit. The storage unit stores a first program code and a second program code. The first logic unit, which is coupled to an interface, executes the first program code. The second logic unit, which is coupled to the interface and the storage unit, reads the second program code from the storage unit, executes the second program code, and transmits the first program code to the first logic unit via the interface.

### BACKGROUND OF THE INVENTION

1. Field of the Invention

The present invention relates to optical storage devices, especially to program codes loading in optical storage devices.

2. Description of the Prior Art

Please refer to FIG. 1, which shows a control system 100 of a typical optical disc drive. The control system 100 includes primarily a servo engine 120 utilized for driving an optical disc 110 and a data processing unit 130 utilized for processing the data stored on the optical disc 110. The servo engine 120 and the data processing unit 130 communicate with each other via respective interfaces 122 and 132. For example, the servo engine 120 controls the rotation of the optical disc 110 and reads data from the optical disc 110. Next, the servo engine 120 transmits the data read from the optical disc 110 to the interface 132 via the interface 122. The data processing unit 130 receives the data stored on the optical disc 110 via the interface 132 and then processes the data (e.g., decodes the data). Generally, the interfaces 122 and 132 can be either an Integrated Drive Electronics (IDE) interface or a Serial Advanced Technology Attachment (SATA) interface. In the servo engine 120, the memory 121 stores the program code 125 that is required by the servo engine 120 during normal operation. That is, when the servo engine 125 is operating, the program code 125 will be loaded into another memory (e.g. DRAM) 124, which has a higher data accessing speed, such that the microprocessor 123 can access the program code 125 more efficiently. Similarly, in the data processing unit 130, the memory 131 stores the program code 135 which is required by the data processing unit 130 during normal operation, and the memory (e.g. DRAM) 134 is utilized to temporarily store the program code 135 such that the microprocessor 133 can access the program code 135 more efficiently. It is well known in this industry that the memory 121 and the memory 131 are non-volatile storage such as read only memories (ROMs), flash memories, or hard drives.

As shown in FIG. 1, in the control system 100 the servo engine 120 utilized to drive the optical disc 110 contains the memory 121 for storing program codes. In the control system 100, since the front-end servo engine 120 and the back-end data processing unit 130 (e.g., a MPEG decoder) are not integrated, both the servo engine 120 and the data processing unit 130 require their own individual ROMs or flash memories. As a result, the system cost is increased.

### SUMMARY OF THE INVENTION

Therefore, it is an objective of the claimed invention to provide an apparatus and a method for loading program codes through an interface.

According to embodiments of the claimed invention, an apparatus capable of loading program codes is disclosed. The apparatus includes a storage unit, a first logic unit, and a second logic unit. The storage unit stores a first program code and a second program code. The first logic unit, which is coupled to an interface, executes the first program code. The second logic unit, which is coupled to the interface and the storage unit, reads the second program code from the storage unit, executes the second program code, and transmits the first program code to the first logic unit via the interface.

According to embodiments of the claimed invention, a method for driving a computer system is disclosed. The computer system comprises a first logic unit for executing a first program code, and a second logic unit for executing a second program code. The method includes: providing a storage unit for storing the first program code and the second program code; providing a first interface for transmitting received data to the first logic unit; and providing a second interface for transmitting received data to the first interface. The second logic unit reads the second program code from the storage unit, executes the second program code, and transmits the first program code from the storage unit to the second interface. The first program code is further transmitted to the first logic unit via the first and the second interfaces.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows the block diagram of a control system of a typical optical disc drive.

FIG. 2 shows the block diagram of a control system of an optical disc drive according to a first embodiment of the present invention.

FIG. 3 shows the block diagram of a control system of an optical disc drive according to a second embodiment of the present invention.

FIG. 4 shows the block diagram of a control system of an optical disc drive according to a third embodiment of the present invention.

### DETAILED DESCRIPTION

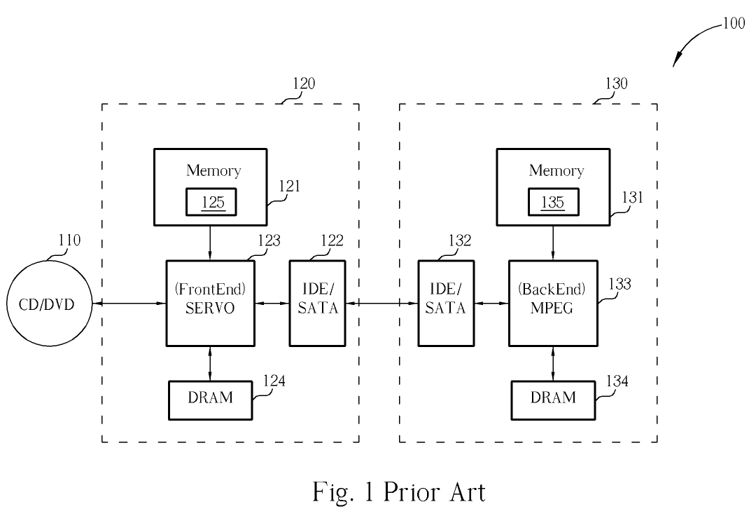

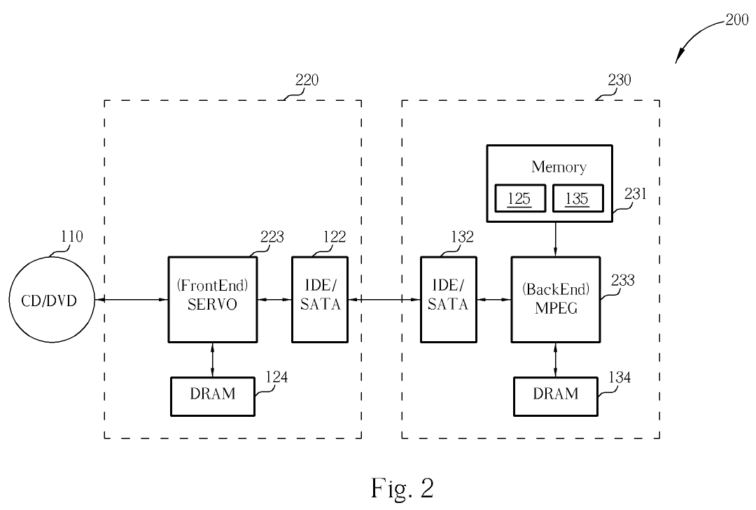

A control system of an optical disc drive serves as an example to describe the present invention, but is not meant to serve as a limitation of the present invention. FIG. 2 shows a control system 200 of an optical disc drive according to a first embodiment of the present invention. In the control system 200 of the first embodiment, a single memory 231 consolidates the functions of the memory 121 and the memory 131 of the control system 100 shown in FIG. 1. The program code 125 and the program code 135 are now stored in the memory 231. The microprocessor 233 of the data processing unit 230 can read the program code 135 stored in the memory 231 and then execute the program code 135 to perform the function of the data processing unit 230. Basically what happened is, the program code 135 is first loaded to the memory 134, then the microprocessor 233 reads the program code 135 from the memory 134 and executes the program code. In addition, the microprocessor 233 reads the program code 125 stored in the memory 231 and then transmits the program code 125 to the microprocessor 223 of the servo engine 220 through the interface 132 and the interface 122. The microprocessor 223 then executes the program code 125 to perform the function of the servo engine 220. Similarly, after the program code 125 is loaded to the memory 124, the microprocessor 223 reads the program code 125 from the memory 134 and then executes the program code. In short, the present embodiment integrates the memory 121 and the memory 131 into a single memory 231 of the control system 200; therefore, some hardware can be saved and the cost is reduced. In addition, the program code 125 and/or the program code 135 can be updated.

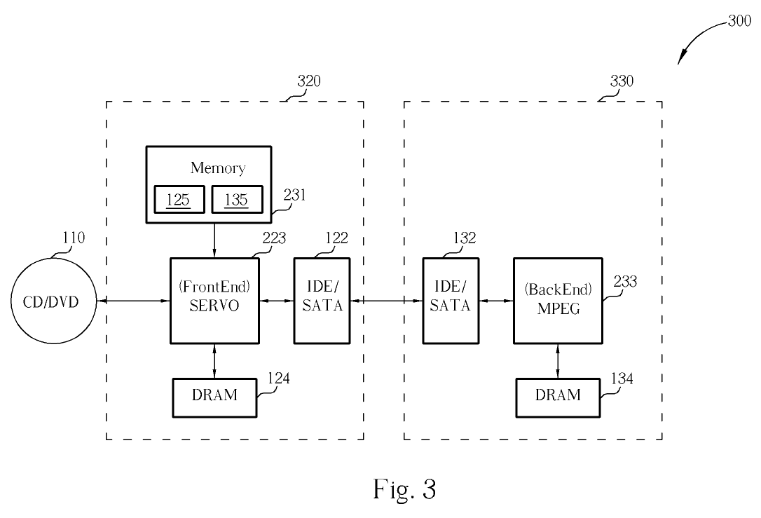

As shown in FIG. 3, the integrated memory 231 can be set in the servo engine 220 instead of in the data processing unit 230. The microprocessor 223 of the control system 300 can read the program code 125 stored in the memory 231, buffer it in the memory 124, and then execute the program code 125 to perform the function of the servo engine 320. In addition, the microprocessor 223 reads the program code 135 stored in the memory 231 and then transmits the program code 135 to the microprocessor 233 of the data processing unit 330 through the interface 122 and the interface 132. The microprocessor 233 then executes the program code 135 buffered in the memory 134 to perform the function of the data processing unit 330.

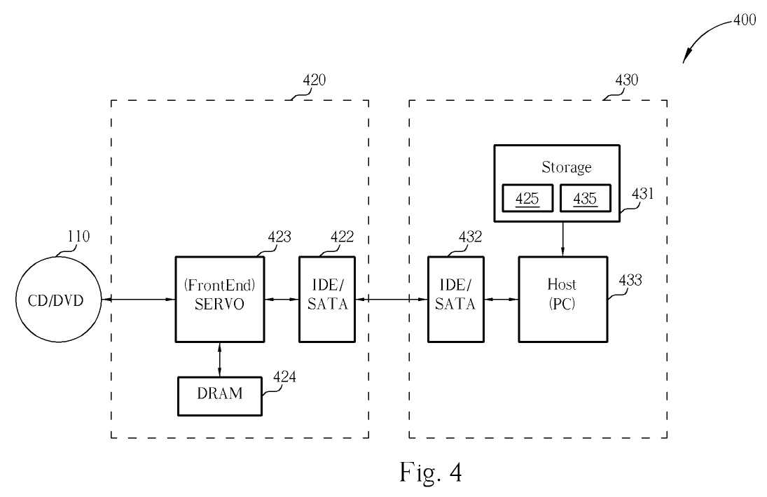

The above-mentioned embodiments describe the control systems 200 and 300 that are utilized in embedded systems such as CD players, DVD players, CD recorders, and DVD recorders, etc. In addition to some of the embedded systems listed herein, the control system of an optical disc drive of the present invention can also be utilized on an ordinary computer. Please refer to FIG. 4 which shows that when the control system 400 is set on an ordinary computer, a servo engine 420 driving the optical disc 110 is set on a optical disc drive, while a data processing unit 430 processing the data stored in the optical disc 110 is set on the host computer. Similar to the embodiment mentioned above, the servo engine 420 and the data processing unit 430 communicate with each other via individual interfaces 422 and 432. Generally, the interfaces 422 and 432 can be IDE or SATA. The servo engine 420 further includes a microprocessor 423 and a memory (e.g., DRAM) 424, and the data processing unit 430 further includes a microprocessor 433 and a storage unit 431. In this embodiment, the microprocessor 433 can be a central processing unit (CPU) of the host, and the storage unit 431 can be the non-volatile storage of the host, such as a hard drive or a floppy disk. The microprocessor 433 of the data processing unit 430 can read the program code 435 stored in the storage unit 431 and then execute the program code 435 to perform the function of the data processing unit 430, such as data encoding and decoding of the optical disc 110. In addition, the microprocessor 433 reads the program code 425 and then transmits the program code 425 to the microprocessor 423 of the servo engine 420 through the interface 432 and the interface 422. The microprocessor 423 executes the program code 425, now buffered in the memory 424, to perform the function of the servo engine 420.

Please note that in some circumstances, to save the space to be occupied of the memory 231 and the storage unit 431, the memory 231 stores a compressed file of the program code 125 or the program code 135 and the storage unit 431 stores a compressed file of the program code 425 or the program code 435. Taking the control system 400 as an example, the microprocessor 433 of the data processing unit 430 reads the compressed file of the program code 435 from the storage unit 431 and then decompresses the compressed file to restore the program code 435. Once restored, the program code 435 can be further executed. Alternatively, the microprocessor 433 reads the compressed file of the program code 425 from the storage unit 431 and then decompresses the compressed file to restore the program code 425. Once restored, the program code 425 is further transmitted to the servo engine 420, and then executed by the microprocessor 423.

In summary, by using interfaces to transmit stored program codes, two different microprocessors residing within a single system can share a single storage unit to store individual program codes. Therefore, since there is no need to utilize two respective storage units, the cost of the system is greatly reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for executing program codes, comprising:
a storage unit for storing a first program code and a second program code;
a first logic unit, coupled to an interface, for executing the first program code; and
a second logic unit, coupled to the interface and the storage unit, for reading the second program code from the storage unit and executing the second program code, and transmitting the first program code stored in the storage unit to the first logic unit via the interface.

2. The apparatus of claim 1, wherein the interface is an IDE interface or a SATA interface.

3. The apparatus of claim 2, wherein the first logic unit is set on an optical disc drive, and the second logic unit is set on a host.

4. The apparatus of claim 1, wherein the storage unit is a non-volatile storage device.

5. The apparatus of claim 4, wherein the non-volatile storage device is a ROM or a flash memory.

6. The apparatus of claim 1, wherein the first program code stored in the storage unit is a compressed file, and the second logic unit reads the compressed file, decompresses the compressed file and then transmits the decompressed file to the first logic unit.

7. The apparatus of claim 1, wherein the apparatus is an optical storage device, the first logic unit is part of a servo engine of the optical storage device, and the second logic unit is part of a data processing unit for processing data read by the optical storage device.

8. The apparatus of claim 1, wherein the first program code, the second program code, or both, can be updated.

9. A method for driving a computer system, wherein the computer system comprises a first logic unit for executing a first program code, and a second logic unit for executing a second program code, the method comprising:
providing a storage unit for storing the first program code and the second program code;
providing a first interface for transmitting received data to the first logic unit; and
providing a second interface for transmitting received data to the first interface;
wherein the second logic unit reads the second program code from the storage unit and executes the second program code, and transmits the first program code from the storage unit to the second interface, and the first program code is further transmitted to the first logic unit via the first and the second interfaces.

10. The method of claim 9, wherein the first and the second interfaces are IDE interfaces or SATA interfaces.

11. The method of claim 9, wherein the first logic unit is set on an optical disc drive and the second logic unit is set on a host.

12. The method of claim 9, wherein the storage unit is a non-volatile storage device.

13. The method of claim 12, wherein the non-volatile storage device is a ROM, a flash memory, or a hard drive.

14. The method of claim 9, wherein the first program code stored in the storage unit is a compressed file, the method further comprising:
decompressing the compressed file to restore the first program code.

15. The method of claim 9, wherein the computer system is an embedded system.

16. The method of claim 9, wherein the first program code, the second program code, or both, can be updated.

17. A method for loading program codes, wherein the method is utilized in a system comprising a first logic unit, a second logic unit, and a storage unit which stores a first program code and a second program code, the method comprising:
the first logic unit reading the first program code stored in the storage unit;
the first logic unit executing the first program code;
the first logic unit reading the second program code stored in the storage unit;
the first logic unit transmitting the second program code to the second logic unit via an interface; and
the second logic unit receiving the second program code.

18. The method of claim 17, wherein the interface is an IDE interface or a SATA interface.

19. The method of claim 17, wherein the second program code stored in the storage unit is a compressed file, the method further comprising:
the first logic unit decompressing the compressed file to restore the second program code.

20. The method of claim 17, wherein the first program code, second program code, or both, can be updated.
